(19) United States
(12) Patent Application Publication
(10) Pub. No.: US 2020/0003305 A1
(43) Pub. Date: Jan. 2, 2020

(54) GUDGEON PIN FOR INTERNAL COMBUSTION ENGINES, SYSTEM, ENGINE AND USE OF A GUDGEON PIN OF THIS TYPE

(71) Applicant: FEDERAL-MOGUL NURNBERG GMBH, NURNBERG (DE)

(72) Inventors: RALF MESKE, SCHWABACH (DE); ROLAND BOHM, PUSCHENDORF (DE); KLAUS LADES, NURNBERG (DE)

(21) Appl. No.: 16/489,846

(22) PCT Filed: Mar. 2, 2018
(86) PCT No.: PCT/EP2018/055160

§ 371 Date: Aug. 29, 2019

(30) Foreign Application Priority Data
Mar. 2, 2017 (DE) 10 2017 203 418.1

(51) Int. Cl. F16J 1/16

(52) U.S. Cl. CPC F16J 1/16

(57) ABSTRACT

The present invention is directed to a gudgeon pin for internal combustion engines, which gudgeon pin consists of case-hardened steel and is characterized in that a ratio of a residual wall thickness of the gudgeon pin to an overall thickness of a case-hardened layer is <2, and a ratio of the inner diameter and the outer diameter of the gudgeon pin is >60%. Furthermore, the present invention is directed to a system comprising the gudgeon pin according to the invention and a piston, wherein the piston has a piston boss with a transverse ovality which corresponds with an ovalization of the gudgeon pin under maximum ignition pressure. The invention also comprises an engine, in particular an internal combustion engine, having the gudgeon pin or the system comprising the gudgeon pin and the piston, and a use thereof for engines, in particular internal combustion engines.

### BACKGROUND

### 1. Technical field

The present invention relates to a gudgeon pin for internal combustion engines, a system comprising a gudgeon pin and piston, an engine with a gudgeon pin or with a system comprising a gudgeon pin and piston, and the use of a gudgeon pin or a system comprising a gudgeon pin and piston for engines, in particular internal combustion engines.

### 2. Related Art

In view of the ongoing efforts to design internal combustion engines in particular more efficiently in a number of respects, a wide range of optimisation paths are being pursued.

One of the options being explored is the optimisation of the gudgeon pin/piston system. With internal combustion engines, the oscillating masses have a major influence on the balancing masses required and the dynamics of the engine. In the case of three-cylinder petrol engines with a small cubic capacity in particular, a drastic reduction in the oscillating masses of the piston and gudgeon pin would make it possible to omit the balance shaft, resulting in a desirable reduction of costs.

A reduction in the weight of the gudgeon pin/piston system is therefore a technically relevant object of the invention. However, when it comes to reducing the total mass of the piston group, the focus has so far largely been on optimizing the piston and the issue has been addressed by, for example, developing and using lighter piston materials. However, as the strength of pistons made from comparatively light aluminium materials has now reached its limit due to the gradual increases in performance while the weight requirements have remained the same, it seems pertinent to look at the gudgeon pin.

Gudgeon pins for internal combustion engines are currently mostly manufactured from steels 16MnCr5 and 17Cr3 that have also undergone case hardening. The manufacture of gudgeon pins made from hardened steel is described in general terms in DE 950297 B, for example.

### SUMMARY

An object of this invention is to provide a gudgeon pin with a reduced mass, without the functional characteristics of the gudgeon pin being negatively impacted.

The gudgeon pin for internal combustion engines is made of a case-hardened steel and has the feature that a ratio of a residual wall thickness of the gudgeon pin to a total thickness of a case-hardened layer is <2, and furthermore a ratio of inner diameter and outer diameter of the gudgeon pin is >60%. The gudgeon pin, as would be understandable to the typical skilled person, preferably is a cylindrically hollow, elongate component that is used to attach the piston and connecting rod and to this end is guided through appropriately designed openings thereof. It also serves to realize the transfer of forces between the eyes of the gudgeon pin and the connecting rod. The gudgeon pin therefore preferably consists solely of this cylindrically hollow, elongate component. The cylindrically hollow design means that a cross-section of the gudgeon pin can be described with an inner diameter and an outer diameter. The difference between the outer diameter and inner diameter divided by 2 also defines the wall thickness of the gudgeon pin. One distinctive feature of the gudgeon pin compared the prior art is that the difference between the outer diameter and inner diameter is smaller than usual. The inner diameter of the gudgeon pin is more than 60% of the outer diameter, whereas it is usually far less than 60%. The present invention is not restricted to a certain upper limit of this value. Provided that the gudgeon pin substantially retains its functionality, inner diameters significantly greater than 60% are also possible. The inner diameter preferably ranges from more than 60% up to and including 80%, where 80% can be regarded as a technically expedient but not restrictive upper limit. This results in a smaller wall thickness of the gudgeon pin and therefore a corresponding saving in material, which in turn reduces the mass of the gudgeon pin. The gudgeon pin according to the invention also consists of a case-hardened steel, which, as the skilled person would normally understand, means that the gudgeon pin material must in the first instance be a suitable case-hardened material that can undergo the usual case hardening process steps of carburizing, hardening/quenching and annealing, and from which the gudgeon pin according to the invention is manufactured using usual manufacturing methods. An advantage of the gudgeon pin is that a defined ratio of a residual wall thickness of the gudgeon pin (i.e. material that has not been case-hardened or portion of gudgeon pin thickness that has not been case-hardened) to a total thickness of a case-hardened layer (i.e. sum of depths/thicknesses of gudgeon pin wall with case hardening) is <2. The case hardening depth for pins can be determined in accordance with ISO 18669-1 (“Internal combustion engines—Piston pins—General specifications). For the present invention, a case hardening is performed directly on the cylindrically hollow gudgeon pin, mostly in the unpolished state, using conventional methods. This means that a case-hardened layer forms on both the outside and the inside of the cylindrically hollow gudgeon pin. The gudgeon pin according to the invention therefore preferably has a case hardening on the outside and inside that is produced starting from the outside and inside surfaces of the gudgeon pin. The case hardening then extends from the outside and inside surfaces of the gudgeon pin to the depth of the gudgeon pin wall. The ratio of the cumulative thickness/depth extension of these case-hardened layers compared to the part of the total wall thickness described above that is substantially not case-hardened is then less than 2. In other words, the case-hardened area of the gudgeon pin wall or the case-hardened layer should have a certain minimum total thickness. However, the present invention is not restricted to leaving behind an unhardened “core” of the gudgeon pin wall. An almost or fully cured gudgeon pin wall such as can result in particular with comparatively particularly large inner diameters, i.e. gudgeon pins with particularly thin walls according to the present invention, is also conceivable. This then results in a ratio of the residual wall thickness of the gudgeon pin to the total thickness of a case-hardened layer of almost 0. Furthermore, the invention is not restricted to identical outside and inside case hardening depths of the gudgeon pin wall or case-hardened layer thicknesses. It is conceivable here to specifically adapt the case hardening depths or layer thicknesses to the particular loads on the outside and inside of the gudgeon pin and adjust them differently as the case may be. This also comprises the option of the outside or inside of the gudgeon pin not being hardened. The overall result is therefore a gudgeon pin with a significantly reduced mass without this compromising functionality or adversely affecting the operating characteristics. In general, this therefore allows the weight of the gudgeon pin to be reduced by 10% to 20% for petrol and diesel pistons without incurring any additional costs. For certain engine types, it may also be possible in some cases to dispense with using balance shafts etc.

It is preferable that the gudgeon pin is not a hybrid (gudgeon) pin. This means that the gudgeon pin according to a preferred embodiment consists only of the cylindrically hollow, shell-like component described here and does not additionally have any further components/elements (inserted therein) such as cores or inserts, as is usually the case with hybrid pins. The gudgeon pin according to the invention is preferably free of inserts, i.e. has no other component (insert) inserted into the cylindrically hollow pin, and is preferably also a single piece. The advantageous characteristics of low weight and high strength, and the functionality of the gudgeon pin as a whole are therefore achieved solely through the design of the cylindrically hollow component, i.e. through the choice of material described above, the case hardening and the dimensions.

As an option, the gudgeon pin described as a whole here can have at least an inner bevel or be provided with the same. This will achieve a further reduction in weight.

In a preferred embodiment of the gudgeon pin, the ratio of the residual wall thickness of the gudgeon pin to the total thickness of the case-hardened layer is <1.5. A preferred lower limit for the thickness ratio is approximately 1.0. This specifically also includes at least the ranges 1.0 to <2.0, 1.0 to <1.5 and 1.5 to <2.0. Overall, the effects described above are further optimised with this selection.

Furthermore, it is preferred that the case-hardened steel of the gudgeon pin according to the invention is a case-hardened steel chosen from the group comprising: 18CrNi8, 18CrNiMo7-6, 20MnCr5 and 20MnCrS5. This represents a further difference between the present invention and the prior art, for which the steel grades 17Cr3 and 16MnCr5 are generally used. The use of higher-strength steel materials, such as 20MnCr5/20MnCrS5 (1.7147/1.7149), 18CrNi8 (1.5920) or 18CrNiMo7-6 (1.6587), allows the substantially thinner wall thickness of the gudgeon pin according to the invention, thus creating an advantageous reduction in the mass moved, while maintaining the same endurance strength. Nevertheless, the tested manufacturing methods can still be used and no changes in method or additional investments are required in this respect.

As an option, the gudgeon pin according to the invention has a surface coating of DLC, ta-C or MoN. This surface coating can be provided on all relevant surfaces of the gudgeon pin as required, for example on the outside and/or inside thereof. This means that the gudgeon pin is advantageously protected against wear in the piston boss, for example, and there are positive impacts on tribological interactions between the system components of the piston group.

A further object of the present invention is to provide a system comprising a gudgeon pin and piston.

The system has the gudgeon pin described above in all its possible and preferred embodiments and a piston, the piston having a piston boss with transverse ovality, i.e. the diameter of the piston boss perpendicular to the cylinder axis is greater by a certain amount than the diameter in the direction of the cylinder axis. The transverse ovality thus defined should ideally correspond to the ovalisation of the gudgeon pin under maximum ignition pressure. The measures previously described to reduce the mass of the gudgeon pin cannot be regarded in complete isolation and they impact the components interacting with the gudgeon pin, in particular the piston itself. To fully realise the technical benefits associated with this, a system approach is required that therefore also includes interacting components. Due to the increased diameter ratio and reduced wall thickness of the gudgeon pin according to the invention, the gudgeon pin can manifest a certain ovalisation during operation, although its bending behaviour remains similar to that of conventional gudgeon pins. The ovalisation can be understood as an elliptical deviation from a circular cross-section of the gudgeon pin. This change in the cross-section shape of the gudgeon pin is counteracted in respect of the endurance strength of the interacting piston boss/gudgeon pin hole by the provision of a corresponding transverse ovality thereof. The system therefore allows for either the total weight of the system and the dynamic masses to be reduced, with the advantages that this will bring, or if the same total weight of the system is retained, for the piston to be reinforced, which, inter alia, increases the overall reliability of the system.

It is preferred that the transverse ovality of the piston boss is ≥0.1% of a piston boss diameter and is particularly advantageous in terms of the endurance strength of the piston boss in interaction with the gudgeon pin according to the invention.

In a preferred embodiment of the system comprising a gudgeon pin and piston, the gudgeon pin has a reduced length. This should be understood to mean that the gudgeon pin differs from a conventional gudgeon pin in its length. The advantage of this is that shortening the gudgeon pin brings a further reduction in the mass of the gudgeon pin and therefore that of the overall system comprising the gudgeon pin and piston.

A further component is an engine, in particular an internal combustion engine having the gudgeon pin or the system comprising the gudgeon pin and piston according to the present invention. The final element of the present invention is the use of the piston according to the invention or the system comprising a gudgeon pin and piston according to the invention for and in engines, in particular internal combustion engines. All of the advantages of the gudgeon pin and system comprising a gudgeon pin and piston previously described are implemented and used both for the engine itself, and for the aforementioned use.

### DETAILED DESCRIPTION

A few specific exemplary embodiments, in particular of the gudgeon pin according to the invention, will be briefly described below.

A specific gudgeon pin with a reduced weight for a diesel engine according to an embodiment is made from 20MnCr5, has an outer diameter of approximately 30 mm, an inner diameter of approximately 19.5 mm, a length of approximately 68 mm and a weight of approximately 0.218 kg. This results in a diameter ratio of approximately 65% and weight reduction of approximately 11% in relation to a gudgeon pin that only has a different inner diameter of approximately 16.8 mm. The above piston type can have a case hardening depth (500 HV) on the outside of the gudgeon pin of approximately 1.08 mm and a case hardening depth (500 HV) on the inside of the gudgeon pin of approximately 1.06 mm. This then results in a ratio of the residual wall thickness of the gudgeon pin to the total thickness of the case-hardened layers on both sides of approximately 1.45. Furthermore, a surface hardness of the gudgeon pin is approximately 82 HRA and a core hardness of the gudgeon pin, i.e. a central zone in the gudgeon pin wall, which is substantially not case-hardened, is approximately 43 HRC.

A further specific gudgeon pin with a reduced weight for a petrol engine is made from 20MnCr5, has an outer diameter of approximately 22 mm, an inner diameter of approximately 14.5 mm, a length of approximately 52 mm and a weight of approximately 0.088 kg. This results in a diameter ratio of approximately 66% and weight reduction of approximately 14.6% in relation to a gudgeon pin that only has a different inner diameter of approximately 12 mm.

Two further specific preferred embodiments of gudgeon pins are made from 20MnCr5 and have an outer diameter in both cases of 20 mm, an inner diameter in both cases of 14.3 mm, and a length of 54 mm. The inner diameter of the piston is approximately 72% of the outer diameter. A first of these gudgeon pins has a case hardening depth (500 HV) on the outside of the gudgeon pin of approximately 0.65 mm and a case hardening depth (500 HV) on the inside of the gudgeon pin of approximately 0.66 mm. In the case of the second gudgeon pin, the values for these measurements are approximately 0.70 mm and approximately 0.72 mm respectively. This in turn results in ratios of the residual wall thickness of the gudgeon pin to the total thickness of the case-hardened layers on both sides of approximately 1.18 and approximately 1.01 respectively. The first gudgeon pin also has a surface hardness of approximately 79 HRA and a core hardness of approximately 47 HRA. In the case of the second gudgeon pin, these values are 80 HRA and 40 HRC.

1. A gudgeon pin for internal combustion engines that consists of a case-hardened steel and wherein a ratio of a residual wall thickness of the gudgeon pin to a total thickness of a case-hardened layer is <2, and
a ratio of inner diameter and outer diameter of the gudgeon pin is >60%.

2. The gudgeon pin according to claim 1, wherein the ratio of the residual wall thickness of the gudgeon pin to the total thickness of the case-hardened layer is <1.5, and a minimum value for the ratio of the residual wall thickness of the gudgeon pin to the total thickness of the case-hardened layer is approximately 1.0.

3. The gudgeon pin according to claim 1, wherein the ratio of the residual wall thickness of the gudgeon pin to the total thickness of the case-hardened layer is in the range of 1.0 to <2.

4. The gudgeon pin according to claim 1, wherein the case-hardened steel is a case-hardened steel chosen from the group consisting of: 18CrNi8, 18CrNiMo7-6, 20MnCr5 and 20MnCrS5.

5. The gudgeon pin, wherein the gudgeon pin has a surface coating of DLC, ta-C or MoN.

6. The gudgeon pin according to claim 1, wherein the ratio of inner diameter and outer diameter of the gudgeon pin is >60% to ≤80%.

7. The gudgeon pin according to claim 1, wherein the gudgeon pin is free of inserts.

8. The gudgeon pin according to claim 1, wherein a gudgeon pin wall is case-hardened from an inside and an outside of the gudgeon pin and an unhardened core remains in the gudgeon pin wall.

9. A system comprising a gudgeon pin according to claim 1, and a piston, wherein the piston has a piston boss with a transverse ovality corresponding to an ovalisation of the gudgeon pin under maximum ignition pressure.

10. The system according to claim 9, wherein the transverse ovality of the piston boss is ≥0.1% of a piston boss diameter.

11. The system according to claim 9, wherein the gudgeon pin has a reduced length.

12. An engine, in particular an internal combustion engine, having the gudgeon pin according to claim 1 or the system according to claims 9.

13. (canceled)

14. The gudgeon pin according to claim 1, wherein a minimum value for the ratio of the residual wall thickness of the gudgeon pin to the total thickness of the case-hardened layer is approximately 1.0.

15. The gudgeon pin according to claim 3, wherein the range is 1.0 <1.5.

16. The gudgeon pin according to claim 1, wherein the gudgeon pin is a single piece.

17. The gudgeon pin of claim 1, wherein the gudgeon pin has an inner bevel.
